(19) United States
(12) Patent Application Publication
(10) Pub. No.: US 2014/0210980 A1
(43) Pub. Date: Jul. 31, 2014

(54) IMAGE ACQUISITION APPARATUS AND IMAGE ACQUISITION METHOD

(71) Applicant: Sony Corporation, Tokyo (JP)

(72) Inventor: Shinji Watanabe, Tokyo (JP)

(73) Assignee: Sony Corporation, Tokyo (JP)

(21) Appl. No.: 14/163,383

(22) Filed: Jan. 24, 2014

(30) Foreign Application Priority Data
Jan. 31, 2013 (JP) 2013-017488

(51) Int. Cl. G02B 21/36

(52) U.S. Cl. CPC G02B 21/365
USPC 348/79

(57) ABSTRACT

An image acquisition apparatus includes a photographing unit, an AF (Auto Focus) processing unit, and a calculation unit. The photographing unit is configured to photograph a pathological sample mounted on a slide glass using an objective lens. The AF processing unit is capable of selectively making a switch between a contrast AF method and a phase difference AF method for focusing a focal point of the objective lens on the pathological sample. The calculation unit is configured to judge a staining method of the pathological sample and select the AF method to be executed by the AF processing unit based on a result of the judgment.

### CROSS REFERENCE TO RELATED APPLICATIONS

This application claims the benefit of Japanese Priority Patent Application JP 2013-017488 filed Jan. 31, 2013, the entire contents of which are incorporated herein by reference.

### BACKGROUND

The present disclosure relates to an image acquisition apparatus such as a digital microscope apparatus and an image acquisition method.

From the past, auto focus (AF: Auto Focus) has been adopted as a focus method used for focusing a focal point of an objective lens of an enlargement photographing system in a digital microscope apparatus on a pathological sample as a photographing target. For example, there is proposed a method of moving a focal position of an objective lens of an enlargement photographing system at a predetermined interval in an optical-axis direction, picking up an image at each movement position, and detecting a position at which an image having a highest contrast out of the picked-up images has been photographed as a focus position (see, for example, Japanese Patent Application Laid-open No. 2011-197283). This type of focus method is called “contrast AF”.

While relatively-high focal accuracy can be obtained with the contrast AF, such a method involves repetitions of moving and evaluating a focal position of the objective lens for searching for the focal position. Therefore, a relatively-long time is required for obtaining the focal position.

In this regard, there is also proposed a microscope apparatus that adopts “phase difference AF” in which light taken in via the objective lens is split into two by a splitter lens, and a focal position and direction are determined from an interval of two imaged images (see, for example, Japanese Patent Application Laid-open No. 2011-090222). By the phase difference AF method, since there is no need to search for a focal point, the focal point can be obtained faster than the contrast AF method. On the other hand, there is a fear that accuracy may be lowered depending on the size of an object and the number of tissues in an image pickup area.

### SUMMARY

In the digital microscope apparatus, although there is a desire to acquire a large number of images of a pathological sample at as high a quality as possible and at a high speed, it is still insufficient.

In view of the circumstances as described above, there is a need for an image acquisition apparatus and an image acquisition method with which a large number of images of a pathological sample can be acquired at as high a quality as possible and at a high speed.

According to an embodiment of the present disclosure, there is provided an image acquisition apparatus including: a photographing unit configured to photograph a pathological sample mounted on a slide glass using an objective lens; an AF (Auto Focus) processing unit capable of selectively making a switch between a contrast AF method and a phase difference AF method for focusing a focal point of the objective lens on the pathological sample; and a calculation unit configured to judge a staining method of the pathological sample and select the AF method to be executed by the AF processing unit based on a result of the judgment.

The pathological sample is separated into those having a large difference between a luminance value of the sample area and a luminance value of a non-sample area (contrast) and a small difference by the staining method. Accuracy of the phase difference AF method is known to depend on a contrast level of an object. In this regard, in the image acquisition apparatus according to the embodiment of the present disclosure, the calculation unit judges the staining method of the pathological sample and selects the AF method to be executed by the AF processing unit based on the result of the judgment. As a result, photographing with an optimal AF method becomes possible, and a pathological image acquisition efficiency can be improved as a whole.

The calculation unit may judge the staining method of the pathological sample by acquiring a thumbnail image of the slide glass on which the pathological sample is mounted, detecting from the acquired thumbnail image, as a label area, an area including a label attached to the slide glass, in which information on the staining method of the pathological sample is described, and reading the information from an image in the detected label area.

The calculation unit may select the phase difference AF method when the judged staining method of the pathological sample is HE staining and select the contrast AF method when the judged staining method of the pathological sample is other staining methods.

The calculation unit may judge the staining method of the pathological sample by acquiring a thumbnail image of the slide glass on which the pathological sample is mounted, detecting from the acquired thumbnail image, as a sample area, an area including the pathological sample, and judging whether red is dominant in color information of the detected sample area.

The calculation unit may judge that the staining method of the pathological sample is HE staining and select the phase difference AF method when red is judged to be dominant, and judge that the staining method of the pathological sample is a method other than the HE staining and select the contrast AF method when red is judged to be non-dominant.

The calculation unit may judge that the staining method of the pathological sample is the HE staining when a mean value of a value obtained by subtracting a green luminance value from a red luminance value for each pixel in the sample area is equal to or larger than a predetermined value.

The calculation unit may judge that the staining method of the pathological sample is the HE staining when a mean value of a value obtained by subtracting a monotone luminance value from a red luminance value for each pixel in the sample area is equal to or larger than a predetermined value.

According to another embodiment of the present disclosure, there is provided an image acquisition method including: judging a staining method of a pathological sample mounted on a slide glass; and focusing a focal point of an objective lens by selectively making a switch between a contrast AF method and a phase difference AF method based on a result of the judgment and photographing the pathological sample using the objective lens.

As described above, according to the embodiments of the present disclosure, a large number of images of a pathological sample can be acquired at as high a quality as possible and at a high speed.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a schematic diagram showing a hardware structure of a digital microscope apparatus as an image acquisition apparatus according to a first embodiment of the present disclosure;

FIG. 2 is a functional block diagram for performing an AF selection by a calculation apparatus of the digital microscope apparatus shown in FIG. 1;

FIG. 3 is a diagram showing an example of a slide to which a label is attached;

FIG. 4 is a graph showing a luminance waveform for each RGB at an edge portion of an HE-stained sample image;

FIG. 5 is a graph showing a luminance waveform for each RGB at an edge portion of a specially-stained sample image;

FIG. 6 is a flowchart showing an operation up to a selection of an optimal AF method to be used for microscopic photographing in the digital microscope apparatus shown in FIG. 1;

FIG. 7 is a flowchart related to the AF selection based on color characteristics of an image;

FIG. 8 is a diagram showing an example of ROI processing; and

FIG. 9 is a diagram showing another example of the ROI processing.

### DETAILED DESCRIPTION OF EMBODIMENTS

Hereinafter, an embodiment of the present disclosure will be described with reference to the drawings.

### First Embodiment

(General Outline of Structure of Digital Microscope Apparatus)

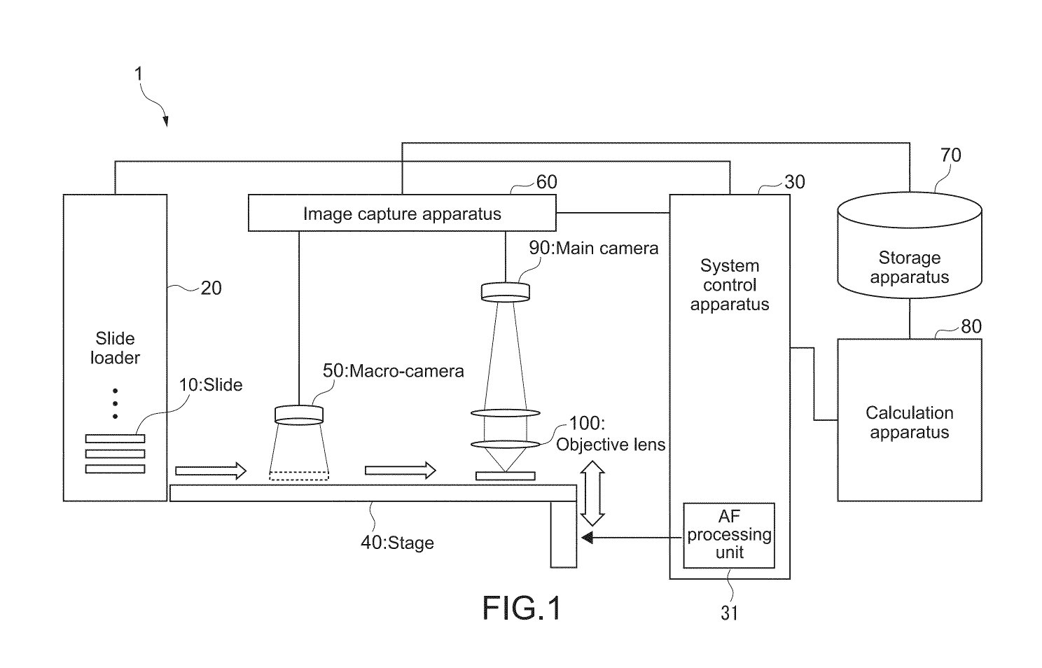

FIG. 1 is a schematic diagram showing a hardware structure of a digital microscope apparatus as an image acquisition apparatus according to a first embodiment of the present disclosure.

The digital microscope apparatus 1 includes a slide loader 20, a system control apparatus 30, a stage 40, a macro-camera 50, an image capture apparatus 60, a storage apparatus 70, a calculation apparatus 80, a main camera 90, and an objective lens 100.

The slide loader 20 stores a plurality of slides 10 (prepared slide) on which a pathological sample is mounted and supplies a target slide 10 to the stage 40 in response to an instruction from the system control apparatus 30.

The system control apparatus 30 controls movements of the entire system of the digital microscope apparatus 1 including the slide loader 20, the stage 40, and the image capture apparatus 60. The system control apparatus 30 includes an AF processing unit 31 capable of selectively making a switch between a contrast AF method and a phase difference AF method for carrying out AF processing for focusing a focal point of the objective lens 100 on a photographing target and executing it.

The stage 40 includes a surface on which the slide 10 can be mounted and is movable in biaxial (x axis and y axis) directions along that surface and a direction orthogonal to that surface (z-axis direction). By moving in the biaxial (x axis and y axis) directions, the stage 40 can successively move the slide 10 supplied from the slide loader 20 to a photographing position of the macro-camera 50 and a photographing position of the main camera 90, for example. By moving in the x- and y-axis directions, the stage 40 can also bring the photographing position of the macro-camera 50 and the photographing position of the main camera 90 to a photographing area of the slide 10. In addition, the stage 40 is movable in the z-axis direction for focusing the focal point of the objective lens 100 on the photographing target.

The macro-camera 50 performs macro-photographing of the entire slide 10 conveyed from the slide loader 20 by the stage 40 in response to an instruction from the image capture apparatus 60.

The main camera 90 photographs the slide 10 conveyed from the slide loader 20 by the stage 40 at an optical magnification used for a pathological diagnosis using the objective lens 100. The objective lens 100 enlarges an image to an appropriate magnification when the main camera 90 photographs the slide 10. The main camera 90 corresponds to a “photographing unit” in the claims of the present disclosure.

In response to an instruction from the system control apparatus 30, the image capture apparatus 60 uses the macro-camera 50 and the main camera 90 to photograph the slide 10. The image capture apparatus 60 stores the photographed thumbnail image and microscopic image in the storage apparatus 70.

The system control apparatus 30 controls the operations of the slide loader 20, the stage 40, the image capture apparatus 60, and the like. The system control apparatus 30 also includes the AF processing unit 31 capable of selectively making a switch between the contrast AF method and the phase difference AF method for carrying out the AF processing for focusing a focal point of the objective lens 100 on a photographing target and executing it.

The storage apparatus 70 stores the thumbnail image photographed by the macro-camera 50 and a sample image photographed by the main camera 90 and supplies the stored images to the calculation apparatus 80 in response to a request from the calculation apparatus 80. The storage apparatus 70 may be incorporated into the calculation apparatus 80.

The calculation apparatus 80 transmits instructions on a photographing order, a photographing method, and the like regarding the slide 10 to the system control apparatus 30.

The calculation apparatus 80 is a generally-used personal computer (PC) or an apparatus conforming to the PC and includes a CPU (Central Processing Unit) and a main memory. The CPU executes programs stored in the main memory to realize functional blocks to be described later.

(General Outline of Flow of Photographing of Pathological Sample)

Next, referring to FIG. 1, a flow of photographing of a pathological sample in the digital microscope apparatus 1 will be described.

First, a user sets the slides 10 in the slide loader 20.

Next, based on an instruction from the system control apparatus 30, a target slide 10 is supplied from the slide loader 20 to the stage 40. After that, by the movement of the stage 40, the slides 10 is moved to the photographing position of the macro-camera 50.

Then, based on an instruction from the system control apparatus 30, the image capture apparatus 60 performs macro-photographing of a thumbnail image of the slide 10 using the macro-camera 50. The photographed thumbnail image is stored in the storage apparatus 70 via the image capture apparatus 60.

Subsequently, the calculation apparatus 80 acquires the thumbnail image from the storage apparatus 70 and carries out processing for calculating an area including a pathological sample (sample area) in the thumbnail image, processing for calculating coordinates of each of a plurality of small areas sectioning the sample area, processing for selecting the AF method of the objective lens 100 of the main camera 90, and the like.

The system control apparatus 30 receives coordinate information of the plurality of small areas from the calculation apparatus 80 and moves the stage 40 in the x-and y-axis directions so as to set the first small area in the photographing range of the main camera 90. It should be noted that the movement can be performed by moving the main camera 90 instead of the stage 40.

Next, focus processing is carried out for focusing a focal point of the objective lens 100 on a pathological sample of the slide 10 by the AF method selected by the calculation apparatus 80, and in the focus state, the main camera 90 photographs the pathological sample. The image photographed by the main camera 90 is stored in the storage apparatus 70 via the image capture apparatus 60.

After that, for the next small area, the movement of the stage 40 for setting the small area in the photographing range of the main camera 90, the focus processing by the selected AF method, and the photographing by the main camera 90 are similarly executed, and the processing described above is repeated for all of the small areas.

(Selection of AF Method)

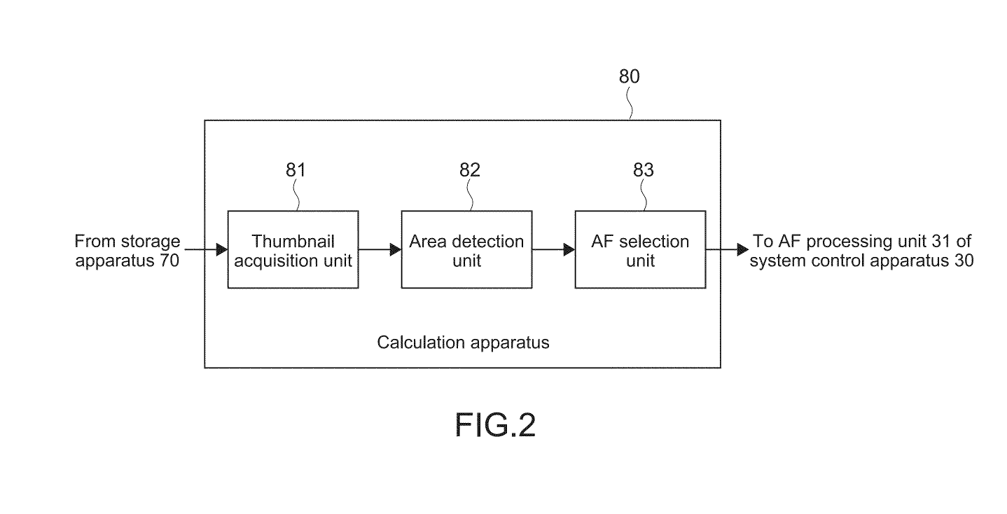

FIG. 2 is a functional block diagram for performing an AF selection by the calculation apparatus 80.

As shown in the figure, the calculation apparatus 80 is operated as a thumbnail acquisition unit 81, an area detection unit 82, and an AF selection unit 83 by the programs stored in the main memory (not shown) of the calculation apparatus 80. Here, the thumbnail acquisition unit 81, the area detection unit 82, and the AF selection unit 83 correspond to a “calculation unit” in the claims of the present disclosure.

The thumbnail acquisition unit 81 reads (acquires) the thumbnail image of each slide 10 from the storage apparatus 70 to the main memory of the calculation apparatus 80. Here, when the thumbnail image is a RAW image, the thumbnail acquisition unit 81 carries out development processing on the acquired RAW image.

The area detection unit 82 detects an area necessary for judging an optimal AF method from the thumbnail image. The area necessary for judging an optimal AF method is as follows.

1. Area of label describing staining method (hereinafter, referred to as “label area”)

2. Area including sample (hereinafter, referred to as “sample area”)

The detection of each area is carried out by, for example, an edge detection or a detection of a location where a luminance value changes sharply.

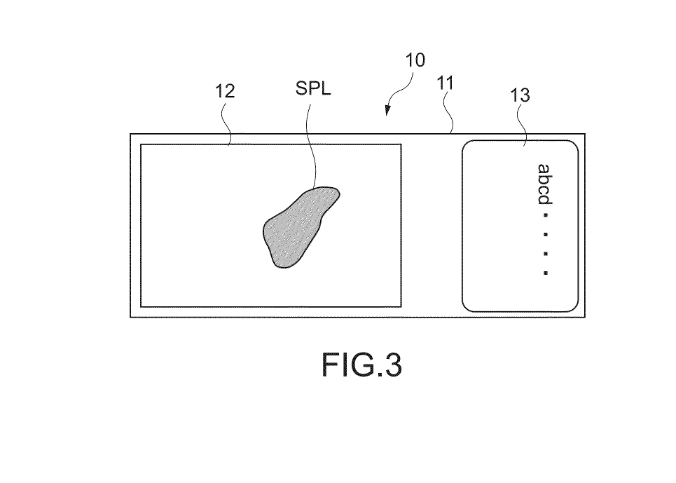

FIG. 3 is a diagram showing an example of the slide 10 to which a label is attached.

As shown in the figure, the slide 10 is mainly constituted of a slide glass 11 and a cover glass 12 for holding a pathological sample SPL with respect to the slide glass 11. At one end portion of the slide glass 11 in a longitudinal direction, for example, a label 13 describing information on the pathological sample SPL, including a staining method of the pathological sample SPL, is attached as necessary.

The AF selection unit 83 judges the staining method of the pathological sample based on an image of at least one of the sample area and the label area and judges an optimal AF method of the objective lens 100 according to the judged staining method. More specifically, the AF selection unit 83 selects the phase difference AF method with respect to an HE-stained sample or a sample that is highly likely an HE-stained sample, and selects the contrast AF method with respect to other samples.

Here, the reasons for adopting the phase difference AF method with respect to an HE-stained sample will be described.

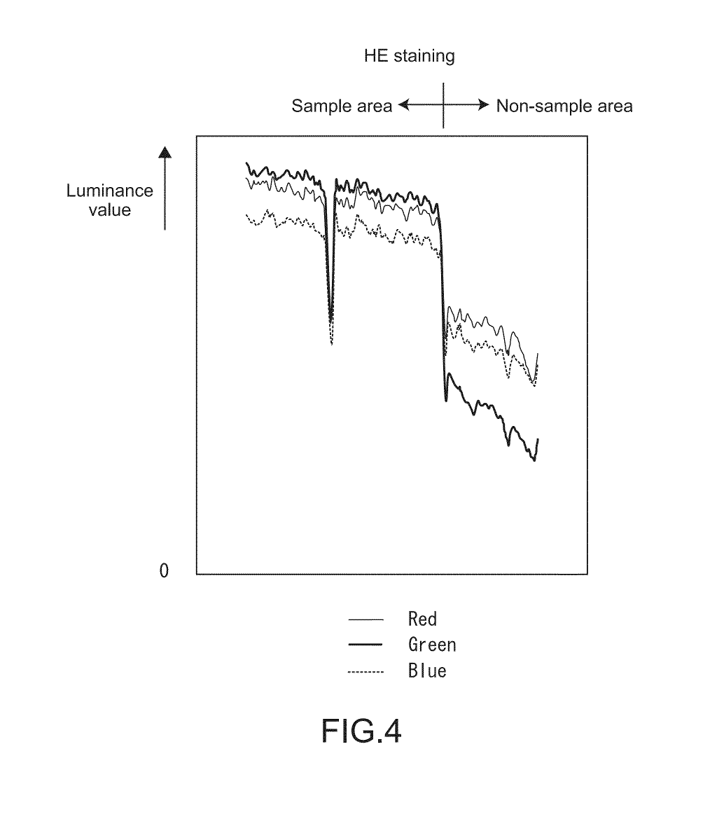

FIG. 4 is a graph showing a luminance waveform for each RGB at an edge portion of an HE-stained sample image.

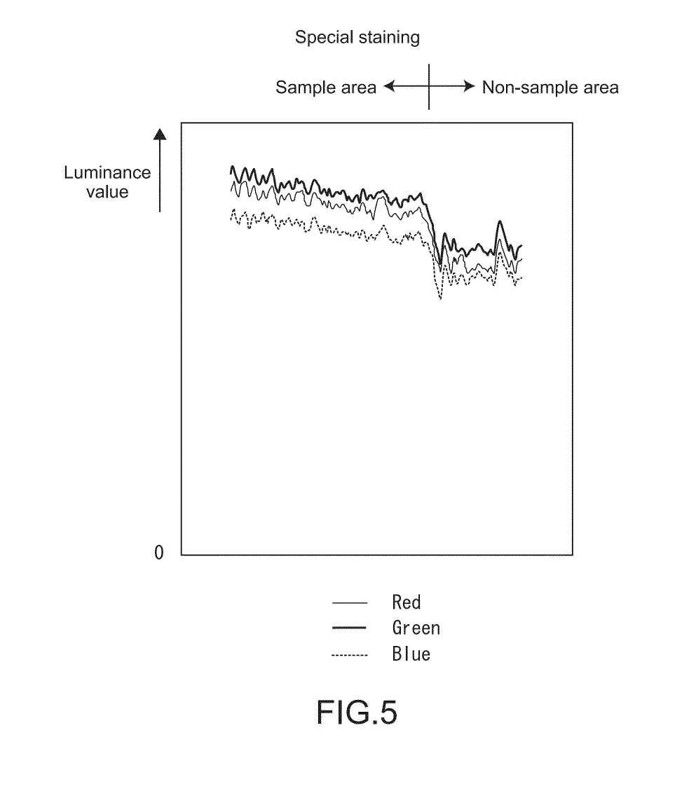

FIG. 5 is a graph showing a luminance waveform for each RGB at an edge portion of a specially-stained sample image.

In the graphs, the ordinate axis represents a luminance value, and the abscissa axis represents a position. In the luminance waveforms of each RGB in the graphs, the luminance changes sharply at a certain point. The waveform on the left-hand side of such a sharp luminance change point is a luminance waveform of each RGB with respect to an image of an area not including a sample (hereinafter, referred to as “non-sample area”), and the waveform on the right-hand side is a luminance waveform of each RGB with respect to an image of the sample area. As can be seen from comparing the luminance waveforms of the graphs, in the HE-stained sample, a difference between the luminance value of the sample area and the luminance value of the non-sample area (contrast) tends to be higher than that of the specially-stained sample. Moreover, samples stained by IHC (Immunohistochemistry) staining have a lower contrast than the HE-stained sample in many cases.

On the other hand, accuracy of the phase difference AF method is known to depend on a contrast level of an object. In the phase difference AF method, light from the lens is split into two, and a defocus amount and direction are obtained from an interval between two images (phase difference) imaged by a pair of line sensors. The interval between two images (phase difference) is a phase difference with which an absolute value of a difference between signal values obtained from pixel positions corresponding to the two line sensors (correlation value) becomes minimum. However, a displacement amount of the correlation value tends to become smaller as the contrast of the object becomes lower, with the result that the phase difference detection accuracy, furthermore, AF accuracy tends to deteriorate.

From the reasons described above, the AF selection unit 83 selects the phase difference AF method as the optimal AF method when it is judged that the slide 10 is of an HE-stained sample. Then, the AF selection unit 83 sets the selected phase difference AF method in the AF processing unit 31 of the system control apparatus 30.

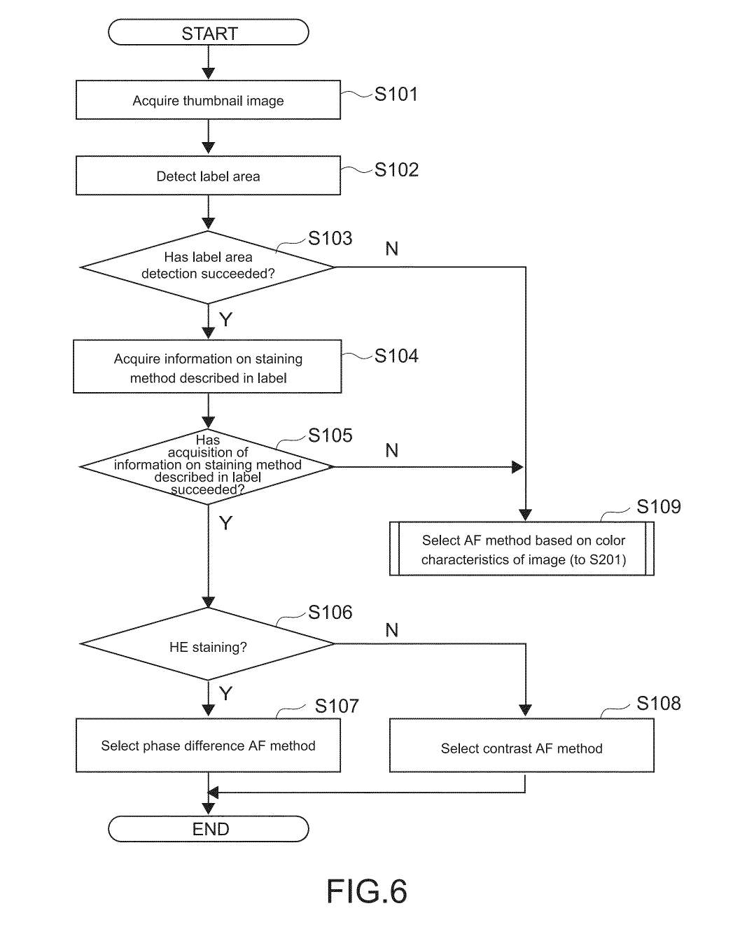

Next, an operation of selecting an optimal AF method in the digital microscope apparatus 1 of this embodiment will be described with reference to the flowchart of FIG. 6.

First, the thumbnail acquisition unit 81 reads a thumbnail image of each slide 10 in the main memory of the calculation apparatus 80 from the storage apparatus 70. It should be noted that when the read thumbnail image is a RAW image, the development processing is carried out that instant (Step S101).

Next, the area detection unit 82 attempts to detect a label area from the thumbnail image (Step S102). When succeeding in the detection of a label area (Y in Step S103), positional information of the label area is transmitted to the AF selection unit 83.

(Selection of AF Method Based on Label Information)

Based on the positional information of the label area transmitted from the area detection unit 82, the AF selection unit 83 attempts to specify an image of the label area and detect and recognize letter patterns with respect to the image of the label area, to thus attempt to acquire information on the staining method described in the label (Step S104).

When succeeding in the acquisition of the information on the staining method (Y in Step S105) and the staining method is the HE staining (Y in Step S106), the AF selection unit 83 sets the phase difference AF method in the AF processing unit 31 of the system control apparatus 30 (Step S107).

When the phase difference AF method is set, the AF processing unit 31 controls the image capture apparatus 60 and the stage 40 to carry out the focus processing of the objective lens 100 with respect to the slide 10 by the phase difference AF method.

Further, when succeeding in the acquisition of the information on the staining method but the staining method is other than the HE staining (N in Step S106), the AF selection unit 83 sets the contrast AF method in the AF processing unit 31 of the system control apparatus 30 (Step S108).

When the contrast AF method is set, the AF processing unit 31 controls the image capture apparatus 60 and the stage 40 to carry out the focus processing of the objective lens 100 with respect to the slide 10 by the contrast AF method.

Furthermore, when the area detection unit 82 fails to detect a label area (N in Step S103) or the area detection unit 82 succeeds in detecting a label area but the AF selection unit 83 fails to acquire the information on the staining method (N in Step S105), the AF selection unit 83 carries out a selection of the AF method based on color characteristics of an image as follows (Step S109).

(Selection of AF Method Based on Color Characteristics of Image)

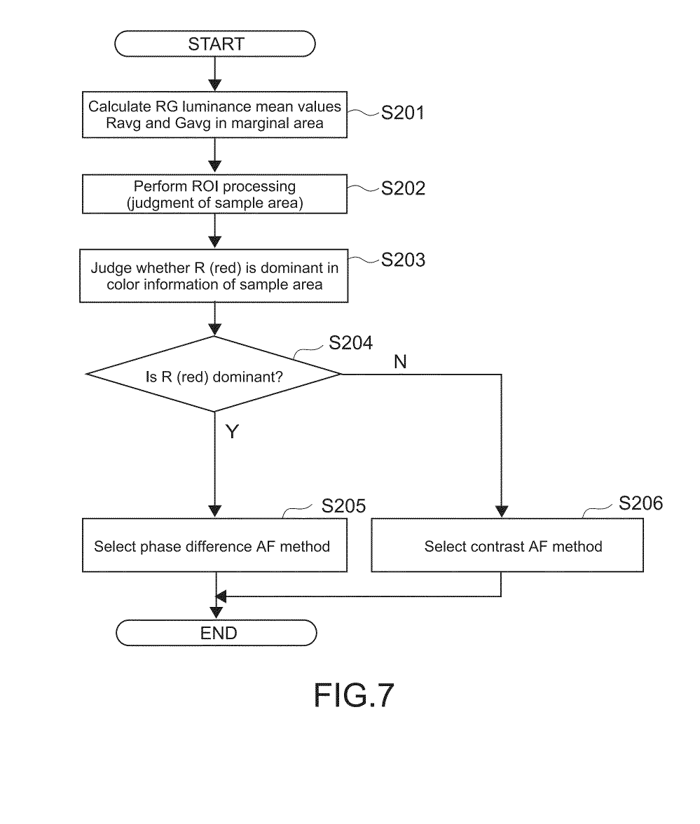

FIG. 7 is a flowchart related to the selection of the AF method based on color characteristics of an image.

Here, a case where a white balance of a thumbnail image is not adjusted will be discussed. In this case, the area detection unit 82 detects a part of a non-sample area from a thumbnail image. A part of the non-sample area in this case is, for example, an area of a certain size (pixel count) in which luminance values of RGB are equal to or larger than a predetermined value set for a judgment of a non-sample area. Subsequently, the area detection unit 82 obtains luminance mean values R_{avg} and G_{avg} for RG in the non-sample area (Step S201).

Calculation expressions for the luminance mean values R_{avg} and G_{avg} are as follows.

$$\begin{matrix}[ Formula 1 ] & \\ {R}_{avg} = \frac{1}{N} \sum \sum R ( x , y ) & ( 1 ) \\ {G}_{avg} = \frac{1}{N} \sum \sum G ( x , y ) & ( 2 )\end{matrix}$$

Here, N represents a pixel count of the detected non-sample area, R (x, y) represents a red luminance value of 1 pixel in the non-sample area, and G (x, y) represents a green luminance value of 1 pixel in the non-sample area.

The calculated luminance mean values R_{avg} and G_{avg} are supplied to the AF selection unit 83 to be used in an evaluation calculation by the AF selection unit 83. The evaluation calculation will be described later.

Next, the area detection unit 82 carries out ROI (Region of Interest) processing for judging a sample area (Step S202). More specifically, the area detection unit 82 judges a sample area from a distribution of pixels whose luminance values precipitously change, for example.

For detecting pixels whose luminance values precipitously change, a method of detecting a boundary of a sample by an edge detection is used, for example.

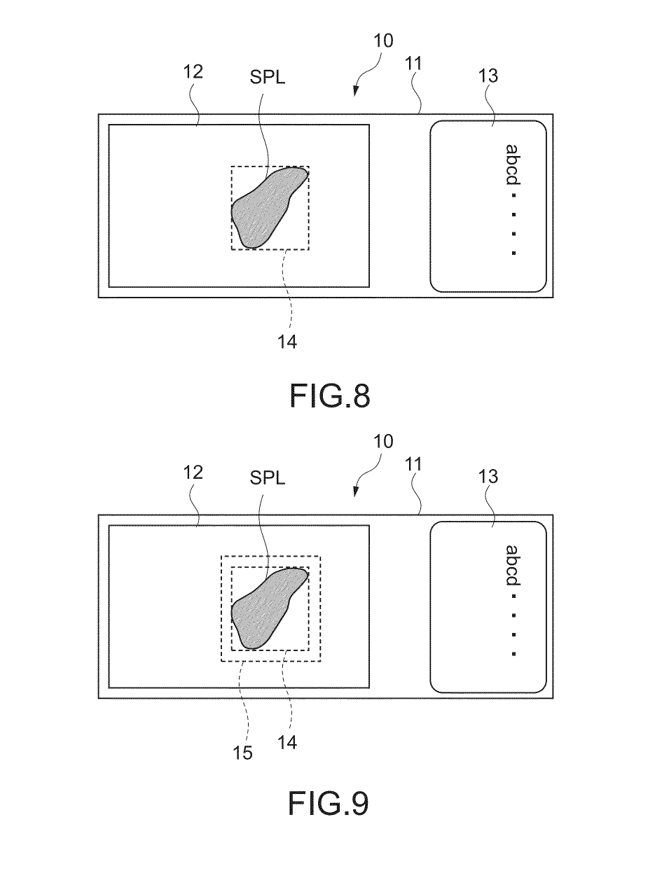

FIG. 8 is a diagram showing an example of the ROI processing.

The area detection unit 82 specifies a rectangular area present in the pathological sample SPL as a sample area 14, for example. It should be noted that the specified sample area 14 does not always need to be a rectangular area circumscribing the pathological sample SPL and may be, for example, an area 15 obtained by adding a margin of a predetermined length outside the rectangular sample area 14 circumscribing the pathological sample SPL as shown in FIG. 9.

Here, a thumbnail image of a slide 10 of an HE-stained sample has a tendency that the contrast between the sample area and the peripheral non-sample area becomes higher than the samples stained by other staining methods such as special staining, but not all of the slides 10 of the HE-stained samples have the same tendency. Further, thumbnail images of slides 10 of samples stained by other staining methods may have a contrast equivalent to the HE-stained sample. Therefore, the sample area judged by the area detection unit 82 is notified to the AF selection unit 83 as a sample area highly likely including an HE-stained sample.

Accordingly, the processing to be carried out by the AF selection unit 83 is narrowed down to the processing on the sample area to thus reduce a processing amount of the AF selection unit 83, with the result that a processing speed can be enhanced. Moreover, an adverse influence of unwanted materials such as dusts present in the non-sample area on the AF selection can be eliminated, and thus judgment accuracy can be improved.

Here, descriptions will return to the descriptions on FIGS. 4 and 5.

Since a cell nucleus becomes blackish by the staining, the accuracy in the sample area generally becomes lower than that in the non-sample area. However, looking at the luminance waveform of FIG. 4 regarding the HE-stained sample, it has been experimentally found by the inventors of the present disclosure that instead of the RGB luminance values equally decreasing in the sample area, lowering of G (green) luminance is more prominent than those of R (red) and B (blue) in most cases. Such a phenomenon is mainly recognized in the case of using the HE staining and has not been recognized in the special staining, IHC staining, HER2 staining, and the like.

The judgment by the AF selection unit 83 is carried out by quantitatively capturing the presence of such a phenomenon.

For example, the AF selection unit 83 first judges whether R (red) is dominant in color information of the sample area based on an evaluation value E obtained by the following expression (Step S203).

$$\begin{matrix}[ Formula 2 ] & \\ E = \frac{1}{N} \sum \sum ( R ( x , y ) - G ( x , y ) * {R}_{avg} . {G}_{avg} ) & ( 3 )\end{matrix}$$

It should be noted that in this expression, a case where a white balance of a thumbnail image is not adjusted will be discussed. Here, R_{avg} represents an R (red) luminance mean value calculated by the area detection unit 82 using Expression (1) above, and G_{avg} represents a G (green) luminance mean value calculated by the area detection unit 82 using Expression (2) above. When the white balance is adjusted, the following Expression (4) is adopted.

$$\begin{matrix}[ Formula 3 ] & \\ E = \frac{1}{N} \sum \sum ( R ( x , y ) - G ( x , y ) ) & ( 4 )\end{matrix}$$

Referring back to the flowchart of FIG. 7, the AF selection unit 83 selects the phase difference AF method and sets it in the AF processing unit 31 of the system control apparatus 30 when R (red) is judged to be dominant based on the evaluation value E (Y in Step S204) (Step S205). Moreover, the AF selection unit 83 selects the contrast AF method and sets it in the AF processing unit 31 of the system control apparatus 30 when R (red) is judged as non-dominant based on the evaluation value E (N in Step S204) (Step S206).

An example of the evaluation conditions regarding whether R (red) is dominant is shown in Table 1.

TABLE 1

| Evaluation value | AF mode |
|---|---|
| E < 0 | Contrast AF |
| E >= 0 | Phase difference AF |

In this example, when the evaluation value E is 0 or more, R (red) is judged to be dominant, and the phase difference AF method is selected. When the evaluation value E is smaller than 0, R (red) is judged as non-dominant, and the contrast AF method is selected.

It should be noted that the calculation method for the evaluation value E and the method of determining the AF method based on the evaluation value E are not necessarily limited to those described above.

For example, although R (red) is judged to be dominant when the evaluation value E is 0 or more in Table 1, the value does not need to be 0 or more.

Moreover, the following calculation expressions in which G of Expressions (3) and (4) above for the evaluation value E is replace by a monotone luminance Y (x, y) may be adopted.

$$\begin{matrix}[ Formula 4 ] & \\ E = \frac{1}{N} \sum \sum ( R ( x , y ) - Y ( x , y ) * {Y}_{avg} / {G}_{avg} ) & ( 5 )\end{matrix}$$

Also in this case, when the white balance is adjusted, the following Expression (6) is adopted.

$$\begin{matrix}[ Formula 5 ] & \\ E = \frac{1}{N} \sum \sum ( R ( x , y ) - Y ( x , y ) ) & ( 6 )\end{matrix}$$

Here, the monotone luminance Y (x, y) is given as follows, for example.

Y(x,y)=0.299R+0.587G+0.114B (7)

Further, Y_{avg} is given by the following Expression (8).

$$\begin{matrix}[ Formula 6 ] & \\ {Y}_{avg} = \frac{1}{N} \sum \sum Y ( x , y ) & ( 8 )\end{matrix}$$

### Effect of Embodiment Etc.

As described above, according to the digital microscope apparatus 1 of this embodiment, an appropriate AF method can be readily selected for each slide 10, with the result that photographing efficiency is improved.

When information on a staining method is described in the label 13 of the slide 10, an operation of selecting an AF method appropriate for the staining method is carried out preferentially based on the information on the staining method. As a result, an appropriate AF method can be readily selected.

Furthermore, according to the digital microscope apparatus 1 of this embodiment, since an appropriate AF method can be selected based on the color characteristics of an image, an appropriate AF method can be selected even in a case where the label 13 is not attached to the slide 10 or a case where reading of the information on the staining method ends in a failure although the label 13 is attached.

### Modified Example 1

Next, a modified example will be described.

In the descriptions above, although the phase difference AF method has been uniquely selected with respect to an HE-stained sample judged based on the label information or color characteristics of an image, even in the case of an HE-stained sample, there are samples that do not satisfy a contrast sufficient for accurately obtaining a focus position by the phase difference AF method, such as a sample mostly constituted of fat cells.

Regarding such a case, the modified example as follows is possible.

For example, when a sample is judged to be stained by the HE staining based on label information or when the evaluation value E is 0 or more based on the color characteristics of an image, the AF selection unit 83 evaluates the number of pixels judged as a boundary of the sample by the edge detection based on a predetermined criteria.

Here, a ratio of the number of pixels judged as a boundary of the sample by the edge detection to the number of pixels of the entire sample area can be said to be an index value onto which a contrast of an entire image of the sample area is reflected. In this regard, the AF selection unit 83 evaluates the index value based on a threshold value preset in consideration of the accuracy in the phase difference AF method. The AF selection unit 83 selects the phase difference AF method when the index value is equal to or larger than the threshold value. Further, when the index value is smaller than the threshold value, the AF selection unit 83 selects the contrast AF method irrespective of the judgment result that is based on the label information or the evaluation value E that is based on the color characteristics of an image.

As a result, an appropriate AF method can be selected for a sample that does not satisfy a sufficient contrast even when the sample is an HE-stained sample.

It should be noted that the present disclosure may also take the following structures.

(1) An image acquisition apparatus, including:

a photographing unit configured to photograph a pathological sample mounted on a slide glass using an objective lens;

an AF (Auto Focus) processing unit capable of selectively making a switch between a contrast AF method and a phase difference AF method for focusing a focal point of the objective lens on the pathological sample; and

a calculation unit configured to judge a staining method of the pathological sample and select the AF method to be executed by the AF processing unit based on a result of the judgment.

(2) The image acquisition apparatus according to (1),

in which the calculation unit judges the staining method of the pathological sample by acquiring a thumbnail image of the slide glass on which the pathological sample is mounted, detecting from the acquired thumbnail image, as a label area, an area including a label attached to the slide glass, in which information on the staining method of the pathological sample is described, and reading the information from an image in the detected label area.

(3) The image acquisition apparatus according to (1) or (2),

in which the calculation unit selects the phase difference AF method when the judged staining method of the pathological sample is HE staining and selects the contrast AF method when the judged staining method of the pathological sample is other staining methods.

(4) The image acquisition apparatus according to (1),

in which the calculation unit judges the staining method of the pathological sample by acquiring a thumbnail image of the slide glass on which the pathological sample is mounted, detecting from the acquired thumbnail image, as a sample area, an area including the pathological sample, and judging whether red is dominant in color information of the detected sample area.

(5) The image acquisition apparatus according to (4),

in which the calculation unit judges that the staining method of the pathological sample is HE staining and selects the phase difference AF method when red is judged to be dominant, and judges that the staining method of the pathological sample is a method other than the HE staining and selects the contrast AF method when red is judged to be non-dominant.

(6) The image acquisition apparatus according to (4) or (5),

in which the calculation unit judges that the staining method of the pathological sample is the HE staining when a mean value of a value obtained by subtracting a green luminance value from a red luminance value for each pixel in the sample area is equal to or larger than a predetermined value.

(7) The image acquisition apparatus according to (4) or (5),

in which the calculation unit judges that the staining method of the pathological sample is the HE staining when a mean value of a value obtained by subtracting a monotone luminance value from a red luminance value for each pixel in the sample area is equal to or larger than a predetermined value.

It should be understood by those skilled in the art that various modifications, combinations, sub-combinations and alterations may occur depending on design requirements and other factors insofar as they are within the scope of the appended claims or the equivalents thereof.

What is claimed is:

1. An image acquisition apparatus, comprising:
a photographing unit configured to photograph a pathological sample mounted on a slide glass using an objective lens;
an AF (Auto Focus) processing unit capable of selectively making a switch between a contrast AF method and a phase difference AF method for focusing a focal point of the objective lens on the pathological sample; and
a calculation unit configured to judge a staining method of the pathological sample and select the AF method to be executed by the AF processing unit based on a result of the judgment.

2. The image acquisition apparatus according to claim 1,
wherein the calculation unit judges the staining method of the pathological sample by acquiring a thumbnail image of the slide glass on which the pathological sample is mounted, detecting from the acquired thumbnail image, as a label area, an area including a label attached to the slide glass, in which information on the staining method of the pathological sample is described, and reading the information from an image in the detected label area.

3. The image acquisition apparatus according to claim 2,
wherein the calculation unit selects the phase difference AF method when the judged staining method of the pathological sample is HE staining and selects the contrast AF method when the judged staining method of the pathological sample is other staining methods.

4. The image acquisition apparatus according to claim 1,
wherein the calculation unit judges the staining method of the pathological sample by acquiring a thumbnail image of the slide glass on which the pathological sample is mounted, detecting from the acquired thumbnail image, as a sample area, an area including the pathological sample, and judging whether red is dominant in color information of the detected sample area.

5. The image acquisition apparatus according to claim 4,
wherein the calculation unit judges that the staining method of the pathological sample is HE staining and selects the phase difference AF method when red is judged to be dominant, and judges that the staining method of the pathological sample is a method other than the HE staining and selects the contrast AF method when red is judged to be non-dominant.

6. The image acquisition apparatus according to claim 5,
wherein the calculation unit judges that the staining method of the pathological sample is the HE staining when a mean value of a value obtained by subtracting a green luminance value from a red luminance value for each pixel in the sample area is equal to or larger than a predetermined value.

7. The image acquisition apparatus according to claim 5,
wherein the calculation unit judges that the staining method of the pathological sample is the HE staining when a mean value of a value obtained by subtracting a monotone luminance value from a red luminance value for each pixel in the sample area is equal to or larger than a predetermined value.

8. An image acquisition method, comprising:
judging a staining method of a pathological sample mounted on a slide glass; and
focusing a focal point of an objective lens by selectively making a switch between a contrast AF method and a phase difference AF method based on a result of the judgment and photographing the pathological sample using the objective lens.
